(19) United States
(12) Patent Application Publication
(10) Pub. No.: US 2004/0249758 A1
(43) Pub. Date: Dec. 9, 2004

(54) Point management program provision server and apparatus

(76) Inventors: Hiroko Sukeda, Tokorozawa (JP); Kazuhiro Ohzeki, Kawasaki (JP); Chiaki Matsumoto, Tokyo (JP); Youichi Horii, Mitaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/651,030

(22) Filed: Aug. 29, 2003

(30) Foreign Application Priority Data
Jun. 3, 2003 (JP) 2003-157445

(51) Int. Cl. G06F 17/60

(52) U.S. Cl. 705/57

(57) ABSTRACT

There is provided a point service system that performs customer information analysis and point management in real time at a low cost, using a cellular phone terminal of a customer. Point management and calculation for the customer information analysis are performed inside the cellular phone terminal of the customer. At a time of purchase, purchase data including at least a customer ID is encrypted and input into the cellular phone terminal, and data updating is performed inside the cellular phone terminal. With this arrangement, a shop does not need to bear a communication cost and the system can be introduced at the low cost. The customer does not need to bear the communication cost, either. Since data management by a server is not always necessary, there is no need to disclose privacy data of the customer. The customer thus can readily take part in the system.

### BACKGROUND OF THE INVENTION

The present invention relates a point service system referred to as an FSP (Frequent Shoppers Program). More specifically, the invention relates to a point management method of managing points and managing and analyzing customer information using a portable terminal, and an apparatus to which the point management method is applied.

As means for winning customers, there is provided a point service system in which points are added according to a usage history of a customer, and a predetermined service is available according to an accumulated point value. Hereinafter, the point service system will be also referred to as a point service. Stamp cards for shopping centers, point services for department stores or the like, and mileage programs for airlines can be pointed out as examples of point services.

There is also proposed a point service where cellular phone terminals, which are common media that can be used any time, are employed in place of point cards. As an example of the point service that uses the cellular phone terminal, a point service disclosed in JP-A-2002-163537 can be pointed out. In this point service, point information and personal information of a customer registered in advance are managed by a server. Thus, by logging in the server or receiving a mail from the server, the point information can be displayed.

There is also provided a point service disclosed in JP-A-2002-15196. In this service, cellular phones are used, and an IC card or an IC chip inserted into the cellular phone includes a customer identifier and point managing means. There is further a technique disclosed in JP-A-2002-109039. In this technique, by reading customer information indicated by a two-dimensional bar code displayed on a screen of the cellular phone by a terminal at a shop, the customer ID is authenticated, and a customer's point can be added and stored in a point card data storage unit inside the cellular phone.

On the other hand, a lot of CRM (Customer Relationship Management) tools have been introduced. With these tools, the usage history of a shop by the customer and a history of point provision to the customer, accumulated in the point service are collected into the server or the like and analyzed, thereby planning marketing strategies and implementing sales promotion.

Customer's usage history information analysis in the CRM is more complex than point processing. Thus, currently, customer data management and analysis are mainly performed on the server. However, there is disclosed a method of performing a calculation for simplified customer information analysis inside the IC card. This method is disclosed in a “CARTES2002 SESAMES2002 Awards Nominated Catalog”, November 2002, PP. 23.

In the conventional point service that uses the cellular phone described in above patent literatures, individual customer information obtained from customer information, a point value, and a result of customer information analysis is managed by the server. Thus, customer authentication needs to be performed on line, so that the shop used by the customer and the customer himself must bear a communication cost. When the individual customer information is managed by the server alone, the customer feels a resistance in view of privacy protection; thus, it often happens that the customer has refused to enter his name or his mail address at the time of membership registration and finally turned down the membership registration. Further, in order to implement the point service described above, the shop needs to provide an always-on connecting environment in which the server is also included. Accordingly, a management system is demanded in which the cellular phone terminal is used but the need for communication with the server is eliminated.

Still further, since the customer information analysis by the server requires complex analytical calculations in many cases, it takes time to obtain the result of the analysis. For this reason, even if the result of the analysis of the customer who has come to the shop is to be confirmed, latest purchase information is not sometimes reflected. Thus, a system is demanded which can readily perform real-time management of the result of the customer information analysis as well, using the cellular phone terminal.

On the other hand, even when batch processing is performed using the terminal, a person who actually purchased or used points must coincide with an owner of the terminal that performs point processing. Moreover, on a side of the shop that serves the customer as well, there is a need to know current customer information.

### SUMMARY OF THE INVENTION

In view of the above problems, the present invention has been made. It is therefore an object of the present invention to disclose a system that manages point data and a result of customer information analysis using the cellular phone terminal without carrying out communication with a server, and with consideration given to information security in particular.

In order to solve problems described above, a portable terminal according to the present invention typically includes:

a data input unit for inputting data;

a data output unit for outputting data;

a data storage unit for recording a personal ID and point data; and

a program execution unit.

The portable terminal controls a point management program. The point management program executed by the program execution unit comprises the steps of:

receiving a personal ID and point data through the data input unit;

comparing the received personal ID with the recorded personal ID;

updating the recorded point data using the received point data when the received personal ID is authorized; and

displaying the updated point data including the received personal ID on a display unit.

With an arrangement, point management can be performed in the portable terminal, and fraudulent point use can also be prevented.

According to the present invention, there is no need to disclose privacy data of the customer. The shop does not need to bear the communication cost and can introduce the point service system at a low cost. Further, the customer does not need to bear the communication cost, either. Thus, the customer can readily take part in the point service system.

Moreover, a large-scale server is not required, so that the costs of introducing and maintaining the point service system are low; thus, introduction of the system is easy. In addition to that, since the portable terminal is employed as a tool, the interface to which the customer feels less resistant can be provided. Since the point value and the result of the customer information analysis are updated in real time, a customer's desire to purchase merchandise can be more enhanced than in a conventional point service.

Other objects, features and advantages of the invention will become apparent from the following description of the embodiments of the invention taken in conjunction with the accompanying drawings.

### BRIEF DESCRIPTION OF DRAWINGS

FIG. 1 shows an overview of a service implemented by the present invention;

FIG. 2 includes diagrams showing a configuration of a point service system according to a first embodiment of the present invention;

FIG. 3 is a diagram showing a configuration of a cellular phone terminal in the point service system according to the first embodiment of the present invention;

FIG. 4 is a diagram showing a configuration of a shop terminal in the point service system according to the first embodiment of the present invention;

FIG. 5 is a flowchart showing a processing flow of a program of the cellular phone terminal;

FIG. 6 is a flowchart showing a processing flow of the program of the shop terminal;

FIG. 7 is a flowchart showing a processing flow of the program of the cellular phone terminal according to other embodiment of the present invention;

FIG. 8 is a flowchart showing a processing flow of the program of the shop terminal according to other embodiment of the present invention;

FIG. 9 shows an example of a screen of the cellular phone terminal;

FIG. 10 shows an example of the screen of the cellular phone terminal;

FIG. 11 shows an example of the screen of the cellular phone terminal;

FIG. 12 includes diagrams showing a configuration of a point service system according to a second embodiment of the present invention, which uses a cellular phone terminal equipped with a camera;

FIG. 13 includes diagrams showing a configuration of a log management system in a point service system according to a third embodiment of the present invention; and

FIG. 14 is a flowchart showing a processing flow of a program provision apparatus.

### DETAILED DESCRIPTION OF THE EMBODIMENTS

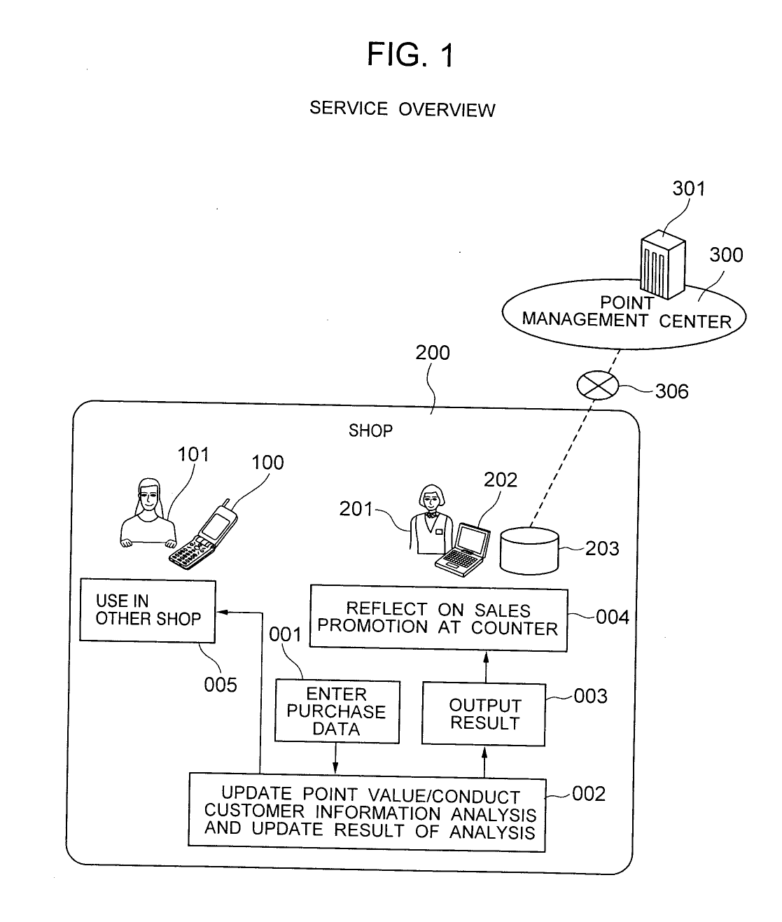

FIG. 1 shows an overview of a service implemented by the present invention. At step 001, purchase data at a shop 200 is entered into a portable terminal 100 such as a cellular phone brought by a customer 101. A point value of the customer 101 is updated using the entered purchase data, so that a result of calculation for customer information analysis is updated, at step 002. The result is immediately presented to a terminal 202 at step 003. At step 004, a clerk 201 reflects this result on sales promotion at the shop: the clerk 201 provides an appropriate service to the customer 101 according to this result. The point value and the result of the customer information analysis are immidiately updated, thereby allowing reference at the time of a next purchase at step 005. Sales information at the shop is stored as sales data 203 as necessary, transmitted to a point management center 300 connected over a network 306, and managed by an administration server 301. Connection between the sales data 203 at the shop and the point management center 300 is not essential for configuring this service.

The calculation for the customer information analysis herein refers to the calculation for finding a shop usage trend of an individual customer by means of various analytical techniques and a data mining technique using purchase history data about frequency of purchase as well as a purchase amount. Comprehensive analysis of the purchase amount and a purchased item during a given interval is conducted; more specifically, comprehensive analysis of what item has been purchased during which period of time is conducted. Based on the result of the analysis, customer differentiation and segmentation are performed. More detailed study than the one just based on the purchase amount thereby becomes possible. Efficient promotion such as service provision with emphasis laid on “Loyal Customers” can be implemented.

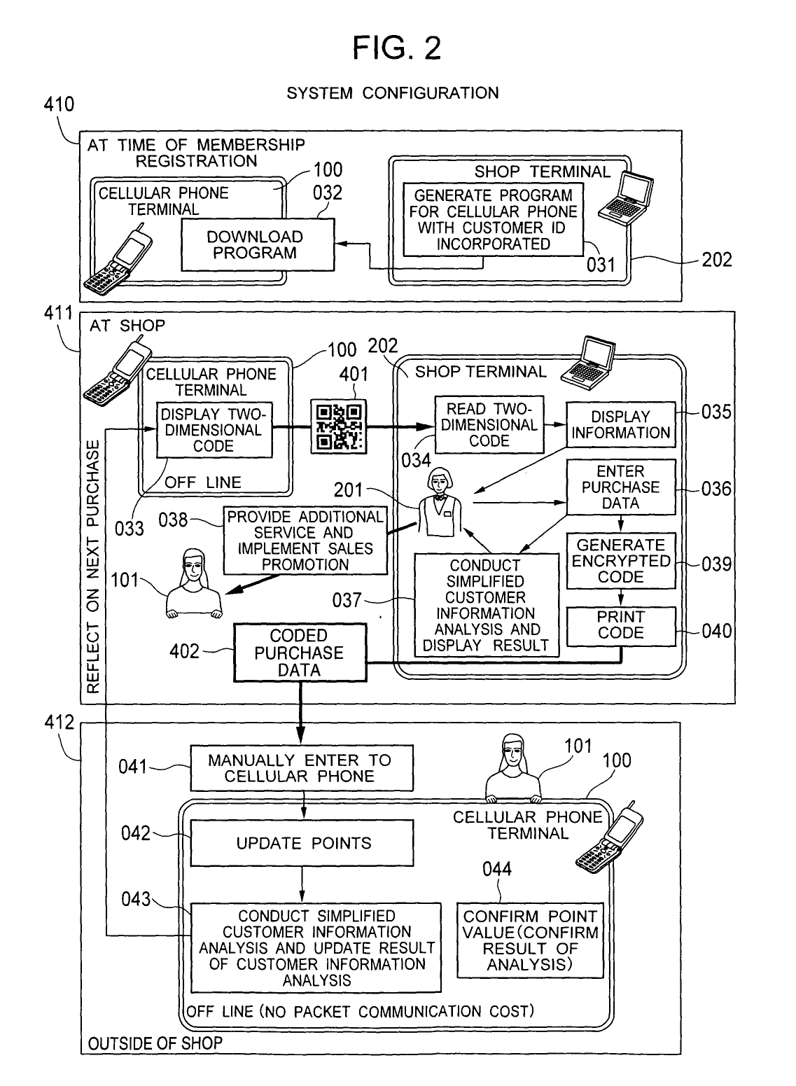

A point service system according to a first embodiment of the present invention will be described below with reference FIGS. 2 to 11 and FIG. 14.

FIG. 2 includes diagrams showing a system configuration of the point service system according to the first embodiment of the present invention. At the time of membership registration at step 410, the shop terminal 202 or the administration server connected to the network issues a unique customer ID and creates a program for the cellular phone, which incorporates the customer ID, at step 031. Then, the program is downloaded into the cellular telephone terminal 100 of the customer at step 032. When the customer 101 has come to the shop at step 411, the program in the cellular phone terminal 100 is started to display customer information including at least the customer ID onto a screen, at step 033. In this embodiment, the customer information is displayed as a two-dimensional code 401. The two-dimensional code 401 includes at least a current point value as well as the customer ID, and is generated inside the cellular phone so that when the customer analysis is conducted, the two-dimensional code 401 includes information on the result of the analysis at a last purchase time. In addition, in order to provide more detailed information, the two-dimensional code may include personal information and a last usage date of the shop. In this embodiment, by presenting the customer ID stored in the cellular phone terminal to the shop terminal at the time of point processing as described above, disclosure and registration of customer information at the time of membership registration in the prior art becomes unnecessary. The clerk 201 reads the two-dimensional code by the shop terminal 202 at step 034, thereby causing information such as the current point value of the customer and the result of the analysis to be displayed on the shop terminal, at step 035. The clerk 201 thus can know the current result of the analysis and the current point value of the customer 101. The shop terminal 202 generates a code that ciphers the customer ID and purchase data entered by the clerk 201, and prints the code on a receipt or in the form of a label at step 040. The clerk 201 passes coded and printed purchase data 402 to the customer 101. The customer 101 manually enters the coded purchase data 402 into the cellular phone terminal at his convenience, at step 041. Then, inside the cellular phone terminal 100, the point value is updated after personal ID authentication, at step 042. If the cellular phone terminal has a function of simplified customer information analysis, the cellular phone terminal conducts the analysis and updates data associated with the result of the analysis, at step 043. Since point management is performed inside the cellular phone terminal, the customer 101 can confirm the current point value and the current result of the customer information analysis at step 044 just by starting up the program in the cellular phone terminal at a desired time even when he is not at the shop at step 412. All of these processes are performed on line. Thus, there is no need to use communication with the server, so that the customer 101 does not need to bear a packet communication cost. Further, by ciphering the customer ID presented by the customer together with the entered purchase data, entry of the purchase data becomes possible both when the customer is not at the shop at step 412 and when he is at the shop at step 411. At the same time, fraudulent acquirement of points issued to a certain customer by other customer is also prevented, thereby providing enhanced security in the service. Still further, by including a different ID into entry data for each transaction and ciphering resulting data, duplicate entry of the data for a single transaction can be prevented. With this arrangement, the security in the service is enhanced.

On the other hand, the shop terminal can also conduct the simplified customer information analysis using received purchase data 036 and the last result of the customer information analysis, and can display the result of the analysis at step 037. The clerk 201 can see the trend of shop usage by the customer, and can utilize this trend for customer service, future additional service, and future sales promotion, at step 038.

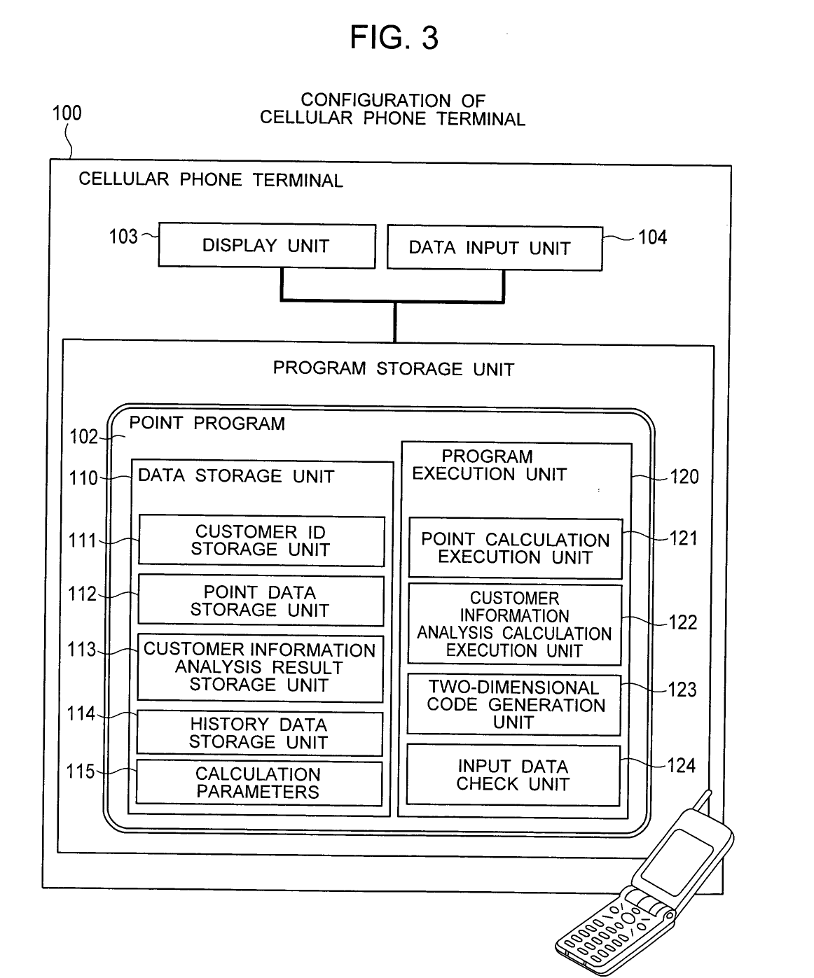

FIG. 3 is a diagram showing a configuration of the cellular phone terminal in the point service system according to the first embodiment of the present invention. The cellular phone terminal 100 includes a program storage unit 105, a display unit 103, and a data input unit 104. A point program 102 is loaded into the program storage unit 105. The point program 102 is constituted from a data storage unit 110 and a program execution unit 120. The data storage unit 110 includes a customer ID storage unit 111, a point data storage unit 112, a customer information analysis result storage unit 113, a history data storage unit 114, and calculation parameters 115. The program execution unit 120 includes a point calculation execution unit 121, a customer information analysis calculation execution unit 122, a two-dimensional code generation unit 123, and an input data checking unit 124, and can perform point management and the calculation for the customer information analysis off line.

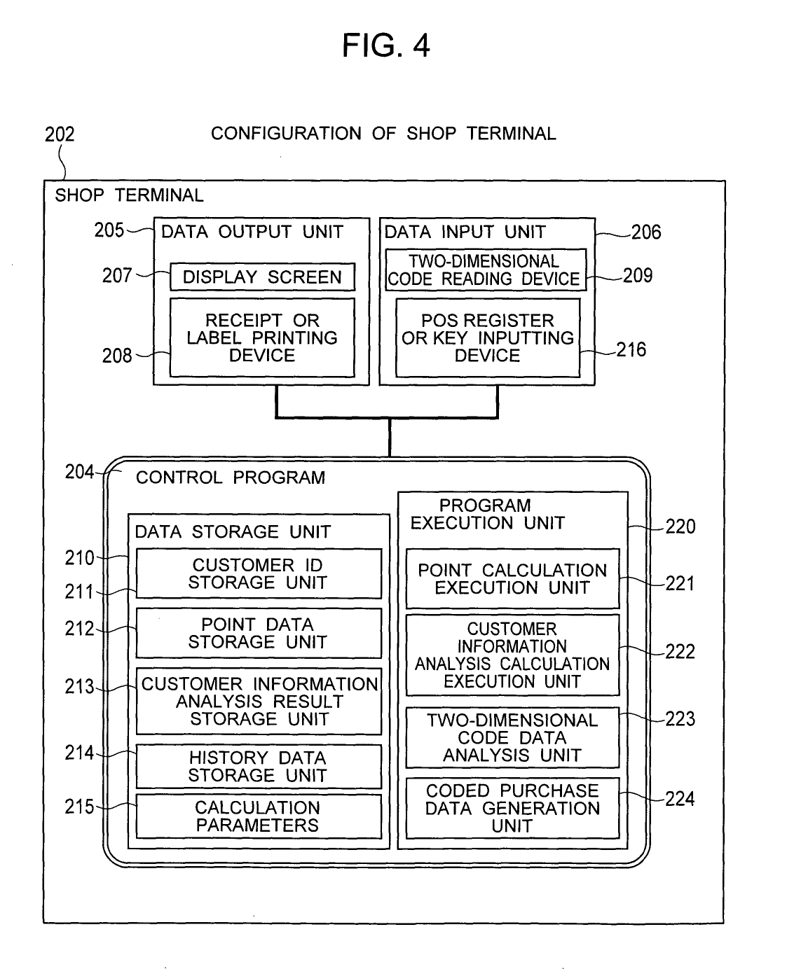

A technique disclosed in “CARTES2002 SESAMES2002 Awards Nominated Catalog”, November, 2002, pp. 23 is employed for the simplified customer information analysis. In this technique, calculation for loyal customer differentiation and point management can be easily performed by an iterative computation using a recurrence formula. Thus, the result of the analysis can be obtained in real time even in the cellular phone terminal. FIG. 4 is a diagram showing a configuration of the shop terminal in the point service system according to the first embodiment of the present invention. The shop terminal 202 includes a control program 204, a data output unit 205, and a data input unit 206. The data output unit 205 includes a display screen 207 and a receipt or label printing device 208. The data input unit 206 includes a two-dimensional code reading device 209 and a POS register or a key inputting device 216. The control program 204 includes a data storage unit 210 and a program execution unit 220. The data storage unit 210 includes a customer ID storage unit 211 for temporarily storing an ID of a customer being currently serviced, a point data storage unit 212 for temporarily storing points of the customer being currently serviced, a customer information analysis result storage unit 213 for temporarily storing the result of the analysis of the customer being currently serviced, a history data storage unit 214, and calculation parameters 215. The program execution unit 220 includes a point calculation execution unit 221, a customer information analysis calculation execution unit 222, a two-dimensional code analysis unit 223, and a coded purchase data generation unit 224.

Referring to FIGS. 3 and 4, in the terminals that perform only point calculation, the customer information analysis result storage units 113 and 213, history data storage units 114 and 214, and customer information analysis execution units 122 and 222 are not always required.

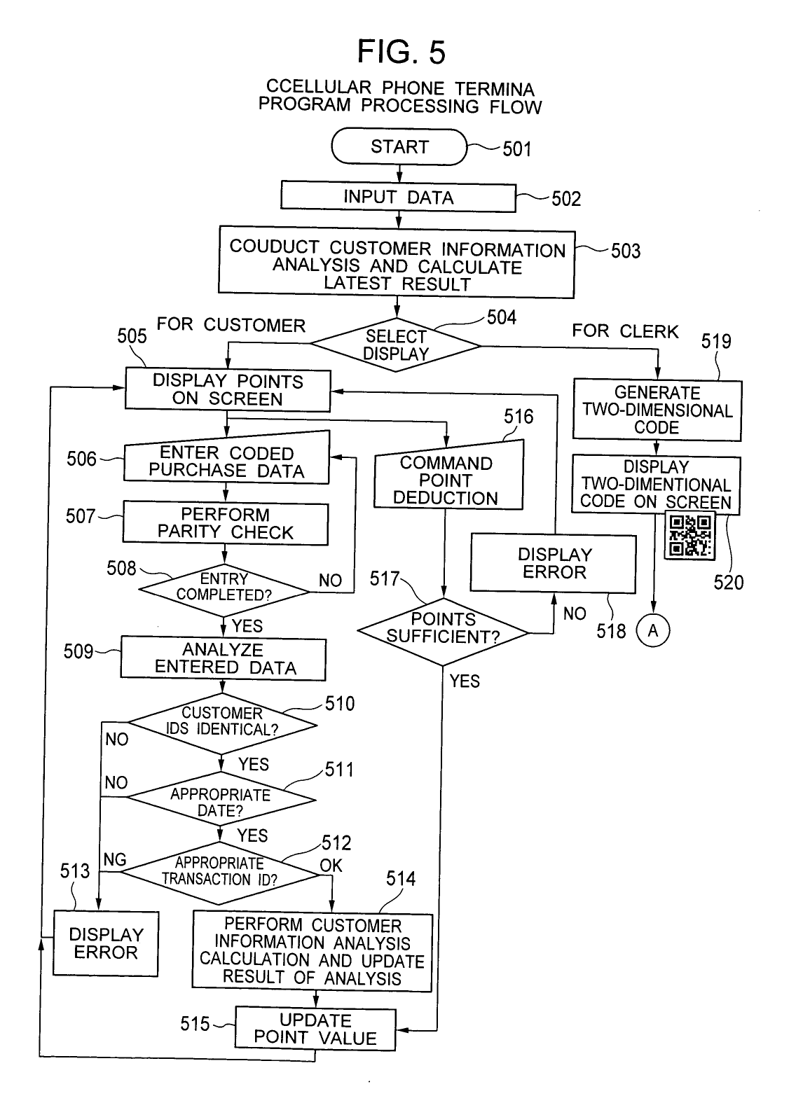

FIG. 5 is a flowchart showing a processing flow of the program of the cellular phone terminal in the system according to the first embodiment of the present invention. When the program execution unit 120 first starts the program according to a command of the customer that holds the cellular phone terminal at step 501, data stored in the cellular phone terminal is read into the program execution unit 120 at step 502 to calculate latest points or the result of the customer information analysis at step 503. Then, display for the customer or the clerk is selected according to a command of the customer at step 504. When display for the customer has been selected, information on the current point value and the like is displayed at step 505. An operation is finished if only the point value is to be confirmed. If purchase data passed from the shop is then entered, the operation proceeds to a process for entry of purchase data at step 506 or commanding for a point deduction process performed at the shop at step 516.

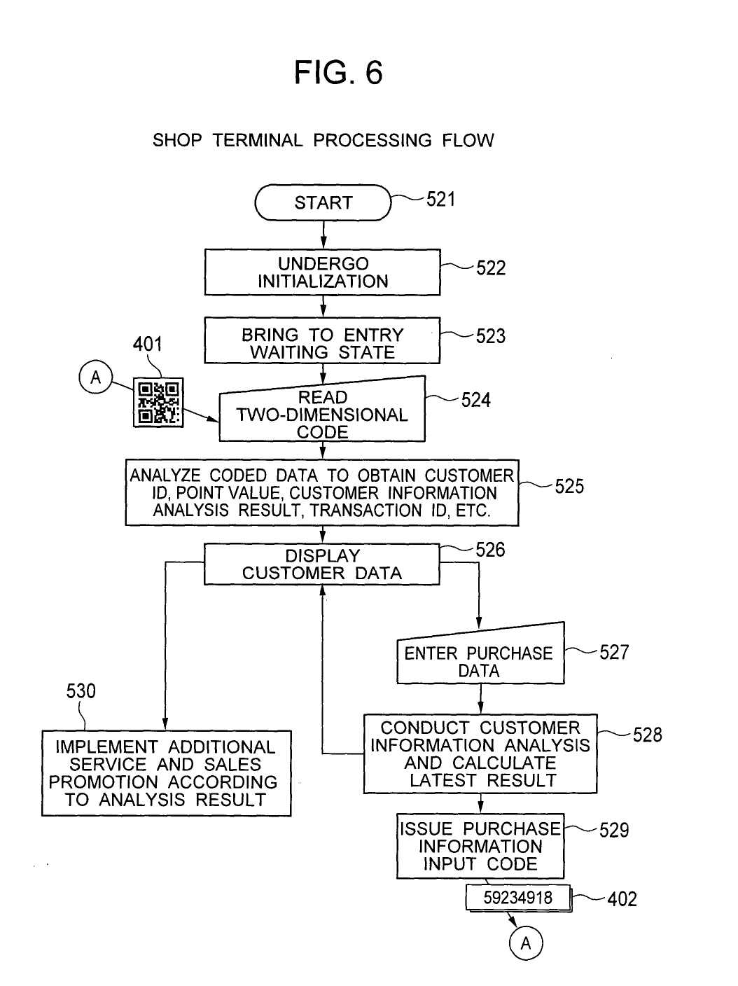

Herein, processes for entering purchase data after step 506 will be first described. In this case, coded purchase data (B) output in processes by the shop terminal, which will be described later with reference to FIG. 6, is required. The customer enters the coded purchase data into the cellular phone terminal through the screen as shown in FIG. 11, at step 506. By using the cellular phone terminal of the customer as a tool, an interface to which the customer feels less resistant can be provided. When the coded purchase data has been input, parity check is performed inside the cellular phone terminal at step 507. At step 508, if the entry has been completed, the operation proceeds to the next step for analysis of the entered data at 509. If the entry has not been completed at step 508, the operation is returned to the purchase data entry process at 506. After completion of the entry, the entered data is analyzed at step 509 to check for a customer ID mismatch at 510 and inappropriate dating at step 511, and at step 512, check whether a transaction ID is appropriate with respect to the transaction ID presented at step 520, which will be described later. Fraudulent entry of a date and an entry error are checked: a date that is too old or too ahead compared with a time when the entry has been performed, for example, is regarded as being improper. When it has been determined that the entered data is not proper, a message indicating the data is not proper is displayed on the display screen at step 513. Then, the operation is returned to display of points at step 505. When it has been determined that the entered data is the proper purchase data, calculation for the customer information analysis is performed, and then the result of the analysis is updated to a latest one at step 514. Then, point value updating is also performed at step 515. The updated values are stored in the point data storage unit 112 and the customer information analysis result storage unit 113, respectively. The operation is then returned to display of points at step 505.

On the other hand, the point deduction process after step 516 is performed after a purchase and service provision using points have been performed at the shop. In order to ensure subtraction of used points, it is desirable in an actual service that the point deduction process be performed, being linked to the shop terminal when the customer has come to the shop. First, when the customer has specified the value of points to be deducted (deduction points) and issues a command for point deduction at step 516, it is checked whether the current point value suffices for deduction at step 517. If the current point value does not suffice, an error indicating a point shortage is displayed on the display screen at step 518. Then, the operation is returned to display of the points. If the points suffice, the point calculation execution unit 121 performs point deduction and updates the point value at step 515. The operation is then returned to display of the points at step 505. In order to prevent the customer from erroneously losing points, it is preferable that the operation of displaying a confirmation message or requiring confirmation of the clerk be performed at the time of the point deduction process.

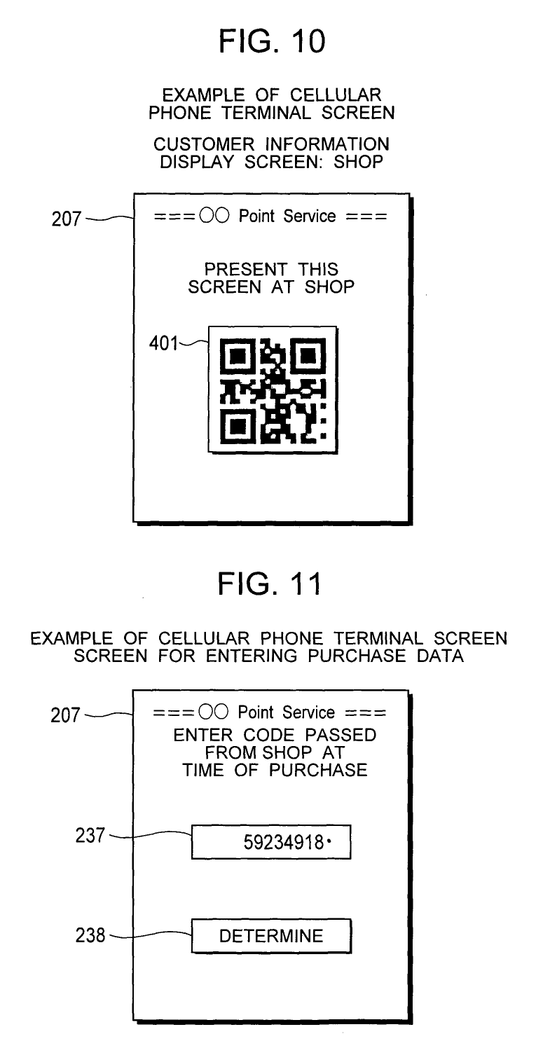

When display for the clerk has been selected by the customer at step 504, customer information including at least the customer ID is presented to the clerk. When a CRM analysis is performed using the shop terminal, information including the current point value and CRM information such as loyal customer ranking information, necessary for processing for the analysis is presented. Though illustration of the two-dimensional code as shown in FIG. 10 is employed as a method of presentation, at step 520 in view of information leakage prevention, other method can be employed for presentation of the information. Then, the operation proceeds to processes at the shop, marked (A). The CRM information may also be read out from a database of the shop terminal using the customer ID as a search key.

FIG. 6 is a flowchart showing a processing flow of the program of the shop terminal in the system according to the first embodiment of the present invention. When the program is started by the program execution unit 220 at step 521, an initialization process is performed at step 522. Then, the shop terminal is brought to a state for waiting for data entry at step 523. When the screen of the cellular phone terminal with the two-dimensional code 401 displayed thereon is presented by the processing in FIG. 5 so as to undergo the processes at the shop marked (A), the two-dimensional code reading device 209 reads the two-dimensional code at step 524. By analyzing this coded data, included information such as the value of the points, the result of the analysis of the customer information such as loyal customer ranking information, and the ID for this transaction as well as the customer ID are obtained at step 525. Among the information obtained, necessary customer data is displayed on the screen at step 526. When the clerk enters the purchase data at step 527, the shop terminal also performs calculation for the customer information analysis at step 528, and displays the latest result of the analysis. By inserting this step, the clerk can serve the customer, based on a display of the loyal customer information, for example, and can further use the latest result of the analysis for future additional service and future sales promotion, at step 530. Then, based on the entered purchase data, an encrypted code 402 for entering purchase information into the cellular phone terminal is generated and issued at step 529. This encrypted code 402 is passed to the customer and is used in the processes on the coded purchase data marked (B) after step 506 in FIG. 5. When the purchase data has been entered, point calculation and calculation for the customer information analysis are performed inside the cellular phone terminal. Then, the data is updated, enabling reference at the time of next use. The purchase information input code includes at least the customer ID entered at step 524, data on the points acquired at a current purchase, and purchase date data. When the transaction ID has also been presented at step 524, the transaction ID and other information such as a purchased item can be included in the purchase information input code. Encryption of the purchase information input code is not always essential. In the present invention, by generating coded data including the customer ID presented earlier, ID checking between the customer ID of the cellular phone terminal and the ID of the purchase information input code is performed by the shop terminal, thereby allowing prevention of fraudulent data entry. Needless to say, encryption further provides enhanced information security. Herein, an encrypted arrangement of numbers indicated by reference numeral 402 is illustrated. By arranging numbers, entry into the cellular phone terminal is facilitated. Further, by printing the arrangement of numbers onto the receipt or the like, the user can readily enter the purchase information input code. In order to prevent fraudulent data entry, there is a need to apply a hash method needs to the purchase information input code; by doing so, original data can be made to be undistinguishable from the purchase information input data.

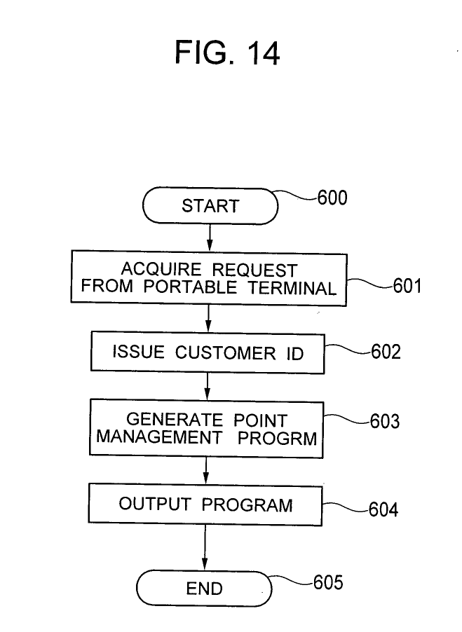

An operation of a program provision apparatus in a membership registration process at step 410 in FIG. 2 will be described in detail. FIG. 14 is a flowchart of the membership registration process. The program provision apparatus corresponds to the shop terminal 202 in FIG. 2, and includes at least a data input and output unit and a control unit. First, the program provision apparatus receives a request to issue the customer ID from the cellular phone terminal at step 601. The request may be obtained over the network or directly input to the shop terminal. Next, the control unit generates the customer ID specific to the cellular phone terminal, at step 602. Next, the program for the cellular phone terminal described above is read from the program storage unit, or generated. Then, by incorporating the customer ID into the cellular phone terminal program, a point management program for the cellular phone terminal is generated at step 603. Incorporation of the customer ID is performed at this step prevents the customer ID from being changed by the cellular phone terminal, and allows the customer ID to be read at the time of execution of the program. Then, the generated program is output at step 604, and the process is finished at step 605. Output of the program can be downloaded over the network or can also be stored in a recording medium.

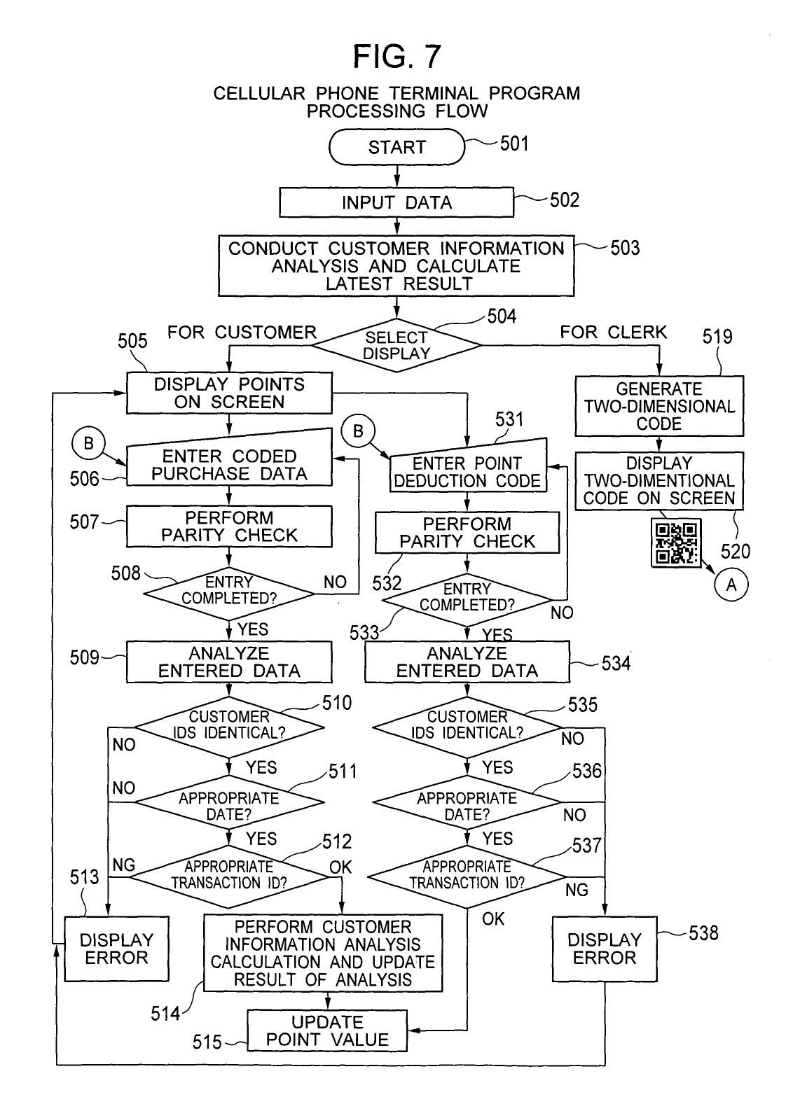

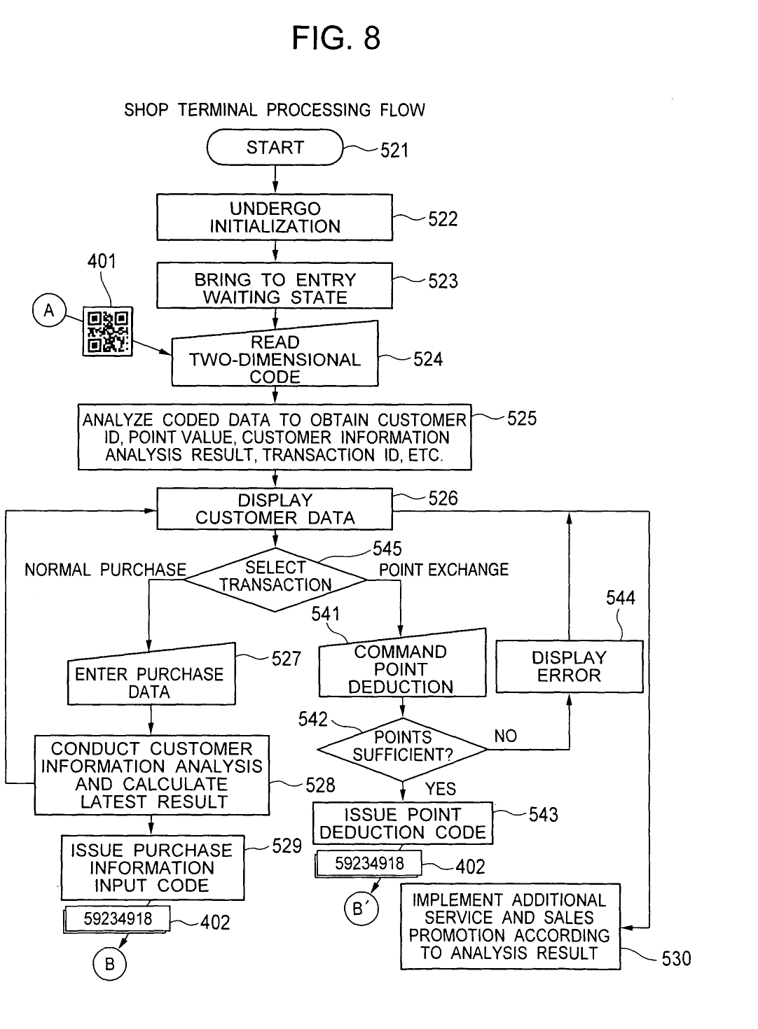

FIGS. 7 and 8 show processing flows of the cellular phone terminal and the shop terminal according to other embodiment of the present invention. In this embodiment, in order to perform the point deduction process more securely, the point deduction process shown at steps 516 to 518 in FIG. 5 are changed to the point deduction process at steps 531 to 538 in FIG. 7. In FIG. 8, in addition to usual processes associated with a purchase at steps 521 to 530, processes at steps 541 to 544, associated with a point change are added.

The point deduction process will be described with reference to FIGS. 7 and 8. When the customer has expressed a wish to use points, the point calculation execution unit 221 at the shop terminal starts a point change process based on FIG. 8. First, points to be deducted are specified and then commanding for point deduction is performed at step 541. Then, it is determined whether the current value of the points stored in the shop terminal or presented from the cellular phone terminal is sufficient for deduction at step 542. If the current point value is not sufficient for deduction, an error message indicating a point shortage is displayed on the display screen at step 544. The operation is then returned to display of customer data at step 526. If the current point value is sufficient for the deduction, the code that encrypts information indicating the point value for deduction, including the customer ID is generated and issued following processes associated with the purchase, at step 543. This encrypted code 402 is passed to the customer and is used for processes after step 531, marked B′ in FIG. 7. In the processes marked B′ in FIG. 7, a point deduction data entry process and determination processes as to validation of point deduction data from step 531 to 538 are performed following purchase data entry processes from step 506 to step 512. If the point deduction data have been entered properly, the point value is updated at step 515. It is desirable that entry of the data for deduction be performed properly at the shop so as to prevent cheating by the customer who will not perform correct point deduction.

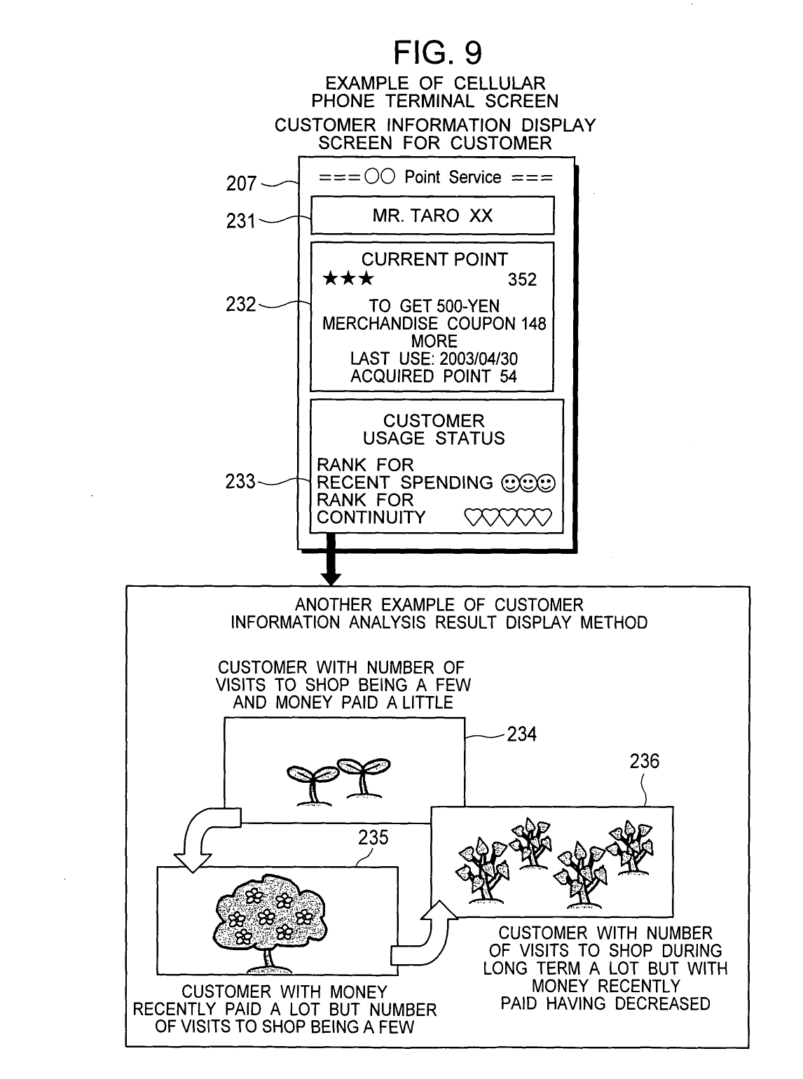

Next, examples of screens of the cellular phone terminal in the point service system according to the first embodiment of the present invention will be described with reference to FIGS. 9 to 11.

FIG. 9 shows the example of a customer information display screen of the cellular phone terminal, for the customer. The display screen 207 includes a customer information display portion 231 for displaying basic information of the customer, a point information display portion 232 for displaying point information of the customer, and a customer information analysis result display portion 233 for displaying the result of the customer information analysis, if any. The customer information display portion 231 basically displays personal information such as the name of the customer. The cellular phone terminal, however, primarily belongs to the customer. Thus, there is not always a need to display the personal information such as the name of the customer, capable of identifying an individual. There is also a usage in which the name of the customer is not entered into the cellular phone terminal at the start of use; and in this case, the customer information display unit 231 may not be needed. The point information display portion 232 displays the current value of the points held by the customer. On the point information display portion 232 in FIG. 9, a symbol • corresponds to 100 points. By listing three symbols • adjacent to the current point value, the point value is visually displayed. On the point information display portion 232, information such as the number of the remainder of points for achieving a next target, which is to acquire a 500-yen merchandise coupon in this embodiment, and the date of last use included in the coded purchase data and received at the cellular phone terminal may be displayed. The value of bonus points should be downloaded together with the customer ID at the time of issuance of the customer ID, as shop information or the like, for example.

The customer information analysis result display portion 233 is a region for displaying the result of the customer information analysis. Whether to display the result of the customer information analysis or not depends on a service policy of the shop that operates this point service, or a service operator. If the downloaded program has a display function, the result of the customer information analysis will be displayed. If the method of presenting this information is effective, the customer himself knows his own rank with respect to the number of visits to the shop. A motivation of the customer to use the shop may be thereby enhanced. On the display screen in FIG. 9, customer's loyalty rank for the shop, which can be analyzed inside the cellular phone terminal is visually shown by the number of symbols by way of an example. Displays 234, 235, and 236 are other examples of display on the customer information analysis result display portion 233. Assume that a rank according to the amount of money paid within the last one week and a rank according to the number of visits to the shop during this one year are obtained from the customer information analysis, for example. Further, assume that a rank according to the amount of money paid recently is indicated by a shape of a tree that assumes from a bud to a tall tree with flowers in full bloom, and a rank according to the number of visits to the shop during a long term is indicated by the number of trees. Then, a type of customer ranking can be confirmed by the display screen 234, 235, or 236: the display screen 234 is employed for displaying the customer with the number of visits to the shop being a few and the amount of money he paid at the shop being a little. The display screen 235 is employed for displaying the customer with the amount of money he recently paid at the shop being a lot, but with the number of visits to the shop during the long term being a few. The display screen 236 is employed for the customer with the number of visits to the shop during the long term being many, but with the amount of money he recently paid at the shop having decreased. In addition to the above-mentioned display method, display of a growth level and a look of a character that change according to the customer ranking may be used. By performing various display for stimulating interest of the customer so as to allow future utilization of the shop, an effect of increasing the motivation of the customer is enhanced.

By providing the display screen as described above, the customer can refer to the current value of the points by using the cellular phone terminal but not by using communication networks, even when he is not at the shop. For this reason, the effect of the point service where expectation of a bonus due to acquirement of points promotes customer's utilization of the shop can be enhanced. Since no communication occurs between the cellular phone and the server, the customer does not need to bear the communication cost. Further, by disclosing the result of the customer information analysis to the customer, the customer can see his loyalty rank in terms of various aspects such as the amount of money paid for recent purchases and the number of visits to the shop during the long term rather than just the value of the points acquired. Thus, the motivation of the customer for next utilization of the shop can be more increased.

FIG. 10 shows an example of the customer information display screen of the cellular phone terminal for the shop. The two-dimensional code 401 obtained by coding the customer information including at least the customer ID is displayed on the display screen 207.

Next, FIG. 11 shows the screen of the cellular phone terminal, for entering purchase data or point deduction data for the customer. The display screen 207 displays at least an input box 237 for entering the purchase data and a determination button 238. A foregoing description was directed to the point service system according to the first embodiment of the present invention with reference to FIGS. 2 to 11.

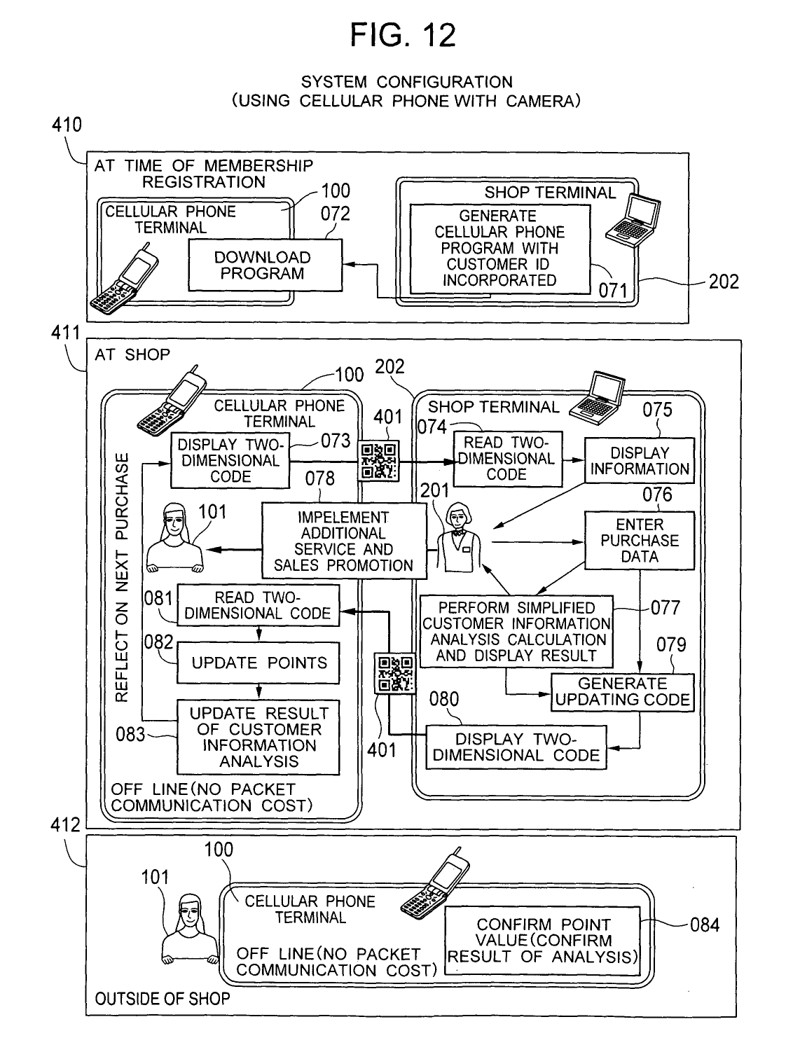

Next, the point service system according to a second embodiment of the present invention will be described with reference to FIG. 12. FIG. 12 includes diagrams showing a configuration of the point service system that uses the cellular phone terminal equipped with a camera. In the point service system in FIG. 2, the customer enters the coded purchase data 402. On contrast therewith, in the point service system in FIG. 12, updating data is generated at step 079 at the shop terminal 202, and converted into the two-dimensional code 401 for display at step 080. The cellular phone terminal 100 images the two-dimensional code and reads the code at step 081. In this embodiment as well, the processes at the cellular phone terminal 100 are basically performed off line. Thus, the customer does not need to bear the packet communication cost.

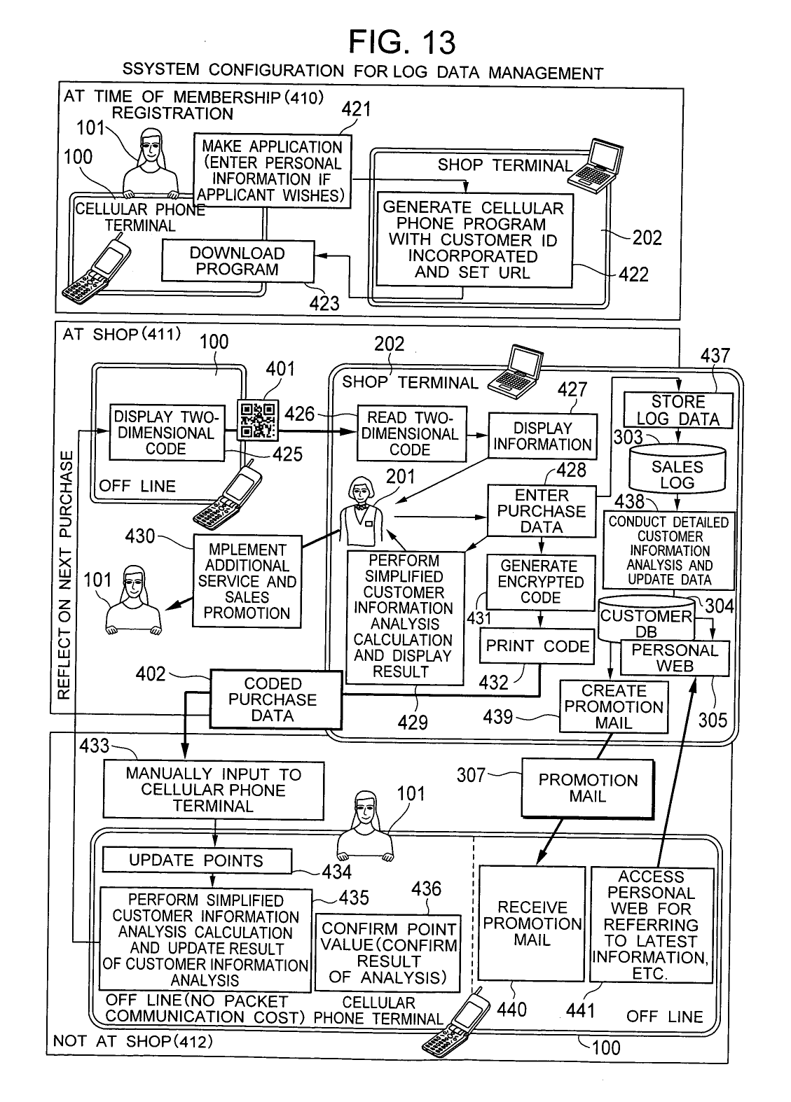

Finally, a log data management system in a point service system according to a third embodiment of the present invention will be described with reference to FIG. 13. In this embodiment, a customer database (DB) is managed at the shop in the system according to the first embodiment shown in FIG. 2, and sales promotion is used in combination with the customer DB management on line, as necessary.

In the process performed at the shop at step 411, data passing is performed almost in the same manner as in the system in FIG. 2. In this system, however, when the clerk has entered the purchase data at step 428, data for a sales log 303 associated with the customer ID is stored at the shop at step 437. The shop can collect detailed data on the customer through detailed customer information analysis using this data, and can reflect the detailed customer data on a future business policy.

If batch management of information from a plurality of shops is to be performed, it is possible to equip the sales log 303 and the customer DB 304 with the administration server connected to the network, for information transfer. Though the present invention is characterized in that disclosure of personal information is not essential, the personal information can also be provided from the customer who permits disclosure of his personal information. In this case, irrespective of whether the personal information is to be disclosed or not, the customer ID and a personal Web 305 are set, and a URL is presented to the customer at step 422. Further, the result of updating points and the like are reflected on data on the personal Web 305 at step 438. Still further, at step 439, a promotion mail is prepared for a customer who discloses his mail address at the time of the membership registration and is set to receive a mail, and is transmitted at an appropriate timing at step 307. While the customer is not at the shop at step 412, the customer can perform on-line processes such as mail reception at step 440 and access to the personal Web at step 441 while performing the same off-line processes as in FIG. 2 at the cellular phone terminal 100.

In addition to the above-disclosed embodiments, even if the present invention is applied to the point service system in which point management is performed at a terminal and point data is entered into the terminal through a communication function, the possibility of a mismatch between a purchaser and a point addition terminal is eliminated, thereby allowing enhancement in the security of the system.

The cellular phone terminal was employed for the foregoing description as the portable terminal. The present invention is not limited to this configuration. Any portable terminal that has a feature of the present invention can be employed.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A point management program for causing a portable terminal to execute a point management method, the portable terminal comprising a data input unit for inputting data, a data output unit for outputting data, a data storage unit for recording customer ID data and point data, and a program execution unit, wherein the point management method comprises the steps of:
outputting the recorded customer ID data through the data output unit;
receiving customer ID data and point data through the data input unit;
comparing the received customer ID data with the recorded customer ID;
updating the recorded point data using the received point data when a customer ID in the received customer ID data is authenticated; and
storing the updated point data including the customer ID in the data storage unit.

2. The point management program according to claim 1, wherein the data storage unit stores user history data and a current result of customer information analysis;
the point management method further comprises the steps of:
outputting the stored result of the customer information analysis as well through the data output unit;
conducting customer information analysis using the received point data when the customer ID is authenticated; and
storing the result of the customer information analysis in the data storage unit.

3. The point management program according to claim 1, wherein the customer ID data and the point data input through the data output unit are encrypted; and
the point management method further comprises the step of:
deciphering the encrypted customer ID data and the encrypted point data and then performing the authentication.

4. The point management program according to claim 2, wherein the customer ID data and the point data input through the data input unit are encrypted; and
the point management method further comprises the step of:
deciphering the encrypted customer ID data and the encrypted point data and then performing the authentication.

5. The point management program according to claim 3, wherein the customer ID data and the point data input through the data input unit are encrypted and coded into numbers.

6. The point management program according to claim 4, wherein the customer ID data and the point data input through the data input unit are encrypted and coded into numbers.

7. The point management program according to claim 1, wherein the point management method further comprises the step of:
displaying the point data and a result of customer information analysis stored in the data storage unit as characters on a display unit according to a request from a user.

8. The point management program according to claim 2, wherein the point management method further comprises the step of:
displaying the point data and the result of the customer information analysis stored in the data storage unit as characters on a display unit according to a request from a user.

9. The point management program according to claim 3, wherein the point management method further comprises the step of:
displaying the point data and the result of the customer information analysis stored in the data storage unit as characters on a display unit according to a request from a user.

10. The point management program according to claim 7, wherein the data output unit is a screen of the display unit; and
the point management method further comprises:
converting the recorded customer data into a two-dimensional code for display on the screen of the display unit.

11. The point management program according to claim 1, wherein the point management method further comprises the steps of:
comparing point data for deduction input through the data input unit of the portable terminal with the recorded point data;
displaying a result of the comparison on a display unit;
subtracting points indicated by the point data for deduction from points indicated by the recorded point data upon reception of an input confirming the deduction through the data input unit when the points indicated by the recorded point data exceed the points indicated by the point data for deduction; and
storing point data resulting from the subtraction in the data storage unit.

12. The point management program according to claim 2, wherein the point management method further comprises the steps of:
comparing point data for deduction input through the data input unit of the portable terminal with the recorded point data;
displaying a result of the comparison on a display unit;
subtracting points indicated by the point data for deduction from points indicated by the recorded point data upon reception of an input confirming the deduction through the data input unit when the points indicated by the recorded point data exceed the points indicated by the point data for deduction; and
storing point data resulting from the subtraction in the data storage unit.

13. A program provision server connected to a portable terminal over a network, wherein the server comprises:
a control unit; and
a communication unit for carrying out communication with the network; and
the control unit generates a customer ID according to a request from the portable terminal, and sends to the portable terminal the point management program as claimed in claim 1 with the generated customer ID incorporated thereinto.

14. A program provision server connected to a portable terminal over a network, wherein the program provision server comprises:
a control unit; and
a communication unit for carrying out communication with the network; and
the control unit generates a customer ID according to a request from the portable terminal, and sends to the portable terminal the point management program as claimed claim 2 with the generated customer ID incorporated thereinto.

15. A program provision server connected to a portable terminal over a network, wherein the server comprises:
a control unit; and
a communication unit for carrying out communication with the network; and
the control unit generates a customer ID according to a request from the portable terminal, and sends to the portable terminal the point management program as claimed in claim 3 with the generated customer ID incorporated thereinto.

16. An apparatus used in a service using a portable terminal for executing the point management program as claimed in claim 1, wherein the apparatus comprises:
a data input unit for acquiring data;
a data output unit; and
a program execution unit; and
the program executed by the program execution unit comprises the steps of:
acquiring customer ID data output from an output unit of the portable terminal through the data input unit;
generating output data including input point data and the customer ID data; and
outputting the output data through the data output unit.

17. An apparatus used in a service using a portable terminal for executing the point management program as claimed in claim 2, wherein the apparatus comprises:
a data input unit for acquiring data;
a data output unit;
a display unit; and
a program execution unit; and
the program executed by the program execution unit comprises the steps of:
acquiring customer ID data and a result of customer information analysis output from an output unit of the portable terminal through the data input unit;
conducting customer information analysis using the acquired result of the customer information analysis and input point data, for display on the display unit;
generating output data including the input point data and the customer ID data; and
outputting the output data through the data output unit.

18. The apparatus according to claim 16, wherein the output data is encrypted as an arrangement of numbers and is printed on a paper.

19. The apparatus according to claim 10, wherein the output data is encrypted as an arrangement of numbers and is printed on a paper.

20. A point management method using a portable terminal comprising a step of:
inputting into a terminal of a cellular phone output coded data including a customer ID and point data, generated at a shop terminal, the customer ID being presented to the shop terminal for storage in the cellular phone;
wherein the cellular phone terminal authenticates the customer ID included in the output coded data using a customer ID stored in a storage unit therein,
adds the point data included in the output coded data to point data stored in the storage unit when the authentication is determined to be valid, conducts customer information analysis, and updates a loyal customer rank stored in the storage unit and records the updated loyal customer rank, and
displays point data and the loyal customer rank stored in the storage unit according to a command of a user.
